(19) United States
(12) Patent Application Publication
(10) Pub. No.: US 2014/0331014 A1
(43) Pub. Date: Nov. 6, 2014

(54) Scalable Matrix Multiplication in a Shared Memory System

(71) Applicant: Silicon Graphics International Corp., Fremont, CA (US)

(72) Inventor: Cheng Liao, Pleasanton, CA (US)

(73) Assignee: Silicon Graphics International Corp., Fremont, CA (US)

(21) Appl. No.: 14/041,974

(22) Filed: Sep. 30, 2013

Related U.S. Application Data
(60) Provisional application No. 61/817,928, filed on May 1, 2013.

(51) Int. Cl. G06F 12/00

(52) U.S. Cl. CPC G06F 12/00
USPC 711/147

(57) ABSTRACT

High performance computing systems perform complex or data-intensive calculations using a large number of computing nodes and a shared memory. Disclosed methods and systems provide nodes having a special-purpose coprocessor to perform these calculations, along with a general-purpose processor to direct the calculations. Computational data transfer from the shared memory to the coprocessor incurs a data copying latency. To reduce this latency as experienced by the coprocessor, a complex computation is divided into work units, and one or more threads executing on the processor copy the work units from the shared memory to a local buffer memory of a computing node. By buffering these data for transfer from the local memory to coprocessor memory, and by ensuring that new data are copied while the coprocessor operates on older data, data copying latency is hidden from the coprocessor.

### CROSS REFERENCE TO RELATED APPLICATION

This application claims the benefit of U.S. Provisional Application No. 61/817,928, filed May 1, 2013, the contents of which are incorporated by reference as if set forth herein in their entirety.

### FIELD OF THE INVENTION

The invention generally relates to improving digital data processing in a high performance computing system and, more particularly, the invention relates to buffering data between a host processor and a co-processor to reduce latency.

### BACKGROUND OF THE INVENTION

High performance computing (“HPC”) systems perform complex or data-intensive calculations using a large number of computing nodes and a shared memory. For example, some HPC systems may be used to multiply matrices that have thousands or even hundreds of thousands of rows, form outer products of vectors having hundreds of thousands of elements. HPC software developers break up such problems into smaller problems that may be executed with relative independence. For example, in a matrix multiplication C=A*B, calculating the value of an element in the matrix C requires as input only a single row of the matrix A and a single column of the matrix B. Thus, the overall multiplication can be divided into a number of independent sub-problems, each of which may be solved by a different node in the HPC system.

Minimizing data communication is important, because each data copy from the global shared memory to the local memory of a node incurs a data copying latency. These latencies, if repeated billions or trillions of times in a calculation, can significantly delay obtaining the final result. To minimize the amount of data communication, HPC software developers often direct a given node to compute several related sub-problems. For example, in a matrix multiplication, only a single column of one matrix must be copied to the node's local memory, while a number of adjacent rows of the other matrix are also copied. In this way, many output values may be calculated, but the single column is only copied once. However, even with this optimization, each row copy incurs the same data copying latency. To further reduce communication latency, the physical memory blocks that store the matrix data need to be distributed among the participating computing nodes in such a way that data locality is maximized and hardware resource contention is minimized.

Moreover, it is known to use an accelerator, such as a coprocessor, in a node to execute calculations that are very floating point intensive. However, data must be copied from the node processor to the coprocessor and the results copied back to the processor. Each of these copies incurs another latency.

### SUMMARY OF VARIOUS EMBODIMENTS

To reduce computational latency as much as possible, illustrated embodiments of the present invention ensure that the coprocessor always has data on which to compute. Multiple threads copy work units from the global shared memory to a local memory of a computing node. By asynchronously transferring these data to the coprocessor, this latency is hidden from the coprocessor because data are always available to transfer from the processor(s) of the node to the coprocessor.

Thus, in a first embodiment of the invention, there is provided a method of reducing latency of a computation having a plurality of work units, in a node of a high-performance computing system having a plurality of nodes that share a shared memory, the node having a processor and a coprocessor. The method first includes executing in the processor a first thread that directs computation of work units on the coprocessor, and executing in the processor one or more second threads. Then, until the computation is completed, the method calls for synchronously copying, by the one or more second threads, a next work unit from the shared memory to one of a plurality of buffer memories in the node, thereby incurring a first data copying latency, and then copying the next work unit from the one of the plurality of buffer memories to the coprocessor for direction of computation by the first thread, thereby incurring a second data copying latency. The copying from the shared memory to the coprocessor is conducted so that once the coprocessor has begun computation of a first work unit, the coprocessor advantageously experiences no data copying latency when accessing subsequent work units for computation.

The method may be varied in a number of ways. For example, the computation may include multiplying a first matrix by a second matrix, and a work unit my be multiplying a set of rows of the first matrix by a set of columns of the second matrix. Alternately, the computation may include forming an outer product of a first set of vectors and a second set of vectors, and a work unit includes forming an outer product of a portion of the first set of vectors and a portion of the second set of vectors. The size of each work unit may be chosen to be sufficiently large so that the duration of computation of each work is greater than the sum of the first data copying latency and the second data copying latency. A second thread may copy work units asynchronously from the plurality of buffer memories to the coprocessor. If so, after starting asynchronous copy of a given work unit, the second thread may further perform a partial computation of a previous work unit in the processor. Also, a variation may include, for a plurality of work units, storing the results of the computation in a portion of an output data buffer in the coprocessor; and when the computation has been performed on the plurality of work units, copying the output data buffer from the coprocessor to the shared memory. A similar variation may include storing the results of a partial computation of each one of the plurality of work units in a portion of an output data buffer in the processor; and when the computation has been performed on the plurality of work units, copying the output data buffer from the processor to the shared memory.

Illustrative embodiments of the invention may also be implemented as a computer program product, that is a non-transitory, tangible computer readable storage medium with computer readable program code thereon. The computer readable code may be read and utilized by a computer system in accordance with conventional processes. Such computer readable code may implement the above-mentioned methods.

In another embodiment, there is provided a high-performance computing system providing reduced latency of a computation having a plurality of work units. The system has a plurality of interconnected nodes, each such node comprising a memory that is shared with other nodes in the plurality of interconnected nodes, a coprocessor configured to perform mathematical computations, and a processor that is coupled to the memory and to the coprocessor. The processor is configured to execute a first thread that directs computation of work units on the coprocessor and to execute one or more second threads. The processor is configured to perform, until the computation is completed, the steps of: synchronously copying, by the one or more second threads, a next work unit from the shared memory to one of a plurality of buffer memories in the node, thereby incurring a first data copying latency, and copying the next work unit from the one of the plurality of buffer memories to the coprocessor for direction of computation by the first thread, thereby incurring a second data copying latency. Once again, the copying from the shared memory to the coprocessor is conducted so that once the coprocessor has begun computation of a first work unit, the coprocessor experiences no data copying latency when accessing subsequent work units for computation. The system embodiment may include all hardware and software necessary to implement the above-mentioned methods.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a logical view of an HPC system in accordance with one embodiment of the present invention.

FIG. 2 schematically shows a physical view of the HPC system of FIG. 1.

FIG. 3 schematically shows details of a blade chassis containing two nodes of the HPC system of FIG. 1.

FIG. 4 schematically shows details of a node of the HPC system of FIG. 1.

FIG. 5 is a graph showing latencies measured using the lmbench pointer chase for transferring data between shared memory of the HPC system and the node.

FIG. 6 shows an exemplary master-slave thread usage in a processor in accordance with an embodiment of the invention.

FIG. 7 shows an exemplary signal timing relating to buffering data in accordance with the embodiment of FIG. 6.

### DESCRIPTION OF ILLUSTRATIVE EMBODIMENTS

To reduce the effects of data transfer latency in an HPC system, illustrative embodiments of the invention deploy multiple threads in a blade processor. A master thread controls the first data transfer from the HPC shared memory to a coprocessor, and computations in the coprocessor, while one or more slave threads execute subsequent data transfers from the HPC shared memory to the local node RAM, and then to buffers in the coprocessor RAM. Two or more buffers are used to store the data in the node RAM; these buffers are copied to the coprocessor RAM for computation. For purposes of this written description and any attached claims, unless the context indicates otherwise, the word “latency” means elapsed time in the usual sense.

Details of illustrative embodiments are discussed below.

### System Architecture

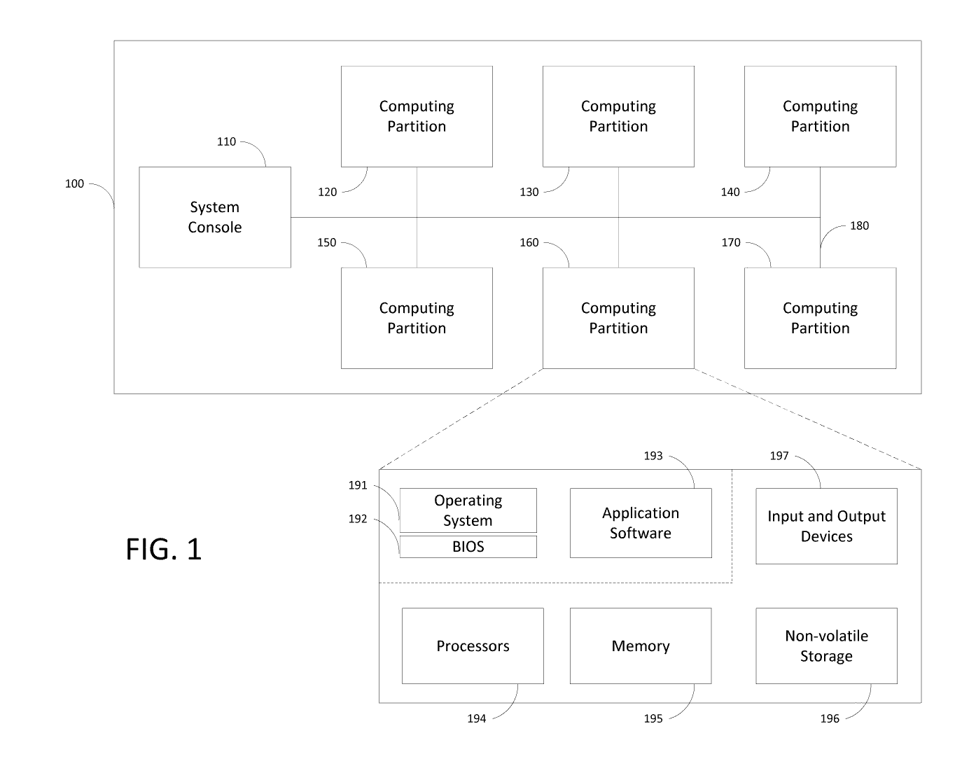

FIG. 1 schematically shows a logical view of an exemplary high-performance computing system 100 that may be used with illustrative embodiments of the present invention. Specifically, as known by those in the art, a “high-performance computing system,” or “HPC system,” is a computing system having a plurality of modular computing resources that are tightly coupled using hardware interconnects, so that processors may access remote data directly using a common memory address space.

The HPC system 100 includes a number of logical computing partitions 120, 130, 140, 150, 160, 170 for providing computational resources, and a system console 110 for managing the plurality of partitions 120-170. A “computing partition” (or “partition”) in an HPC system is an administrative allocation of computational resources that runs a single operating system instance and has a common memory address space. Partitions 120-170 may communicate with the system console 110 using a logical communication network 180. A system user, such as a scientist or engineer who desires to perform a calculation, may request computational resources from a system operator, who uses the system console 110 to allocate and manage those resources. Allocation of computational resources to partitions is described below. The HPC system 100 may have any number of computing partitions that are administratively assigned as described in more detail below, and often has only one partition that encompasses all of the available computing resources. Accordingly, this figure should not be seen as limiting the scope of the invention.

Each computing partition, such as partition 160, may be viewed logically as if it were a single computing device, akin to a desktop computer. Thus, the partition 160 may execute software, including a single operating system (“OS”) instance 191 that uses a basic input/output system (“BIOS”) 192 as these are used together in the art, and application software 193 for one or more system users.

Accordingly, as also shown in FIG. 1, a computing partition has various hardware allocated to it by a system operator, including one or more processors 194, volatile memory 195, non-volatile storage 196, and input and output (“I/O”) devices 197 (e.g., network cards, video display devices, keyboards, and the like). However, in HPC systems like the embodiment in FIG. 1, each computing partition has a great deal more processing power and memory than a typical desktop computer. The OS software may include, for example, a Windows® operating system by Microsoft Corporation of Redmond, Wash., or a Linux operating system. Moreover, although the BIOS may be provided as firmware by a hardware manufacturer, such as Intel Corporation of Santa Clara, Calif., it is typically customized according to the needs of the HPC system designer to support high-performance computing, as described below in more detail.

As part of its system management role, the system console 110 acts as an interface between the computing capabilities of the computing partitions 120-170 and the system operator or other computing systems. To that end, the system console 110 issues commands to the HPC system hardware and software on behalf of the system operator that permit, among other things: 1) booting the hardware, 2) dividing the system computing resources into computing partitions, 3) initializing the partitions, 4) monitoring the health of each partition and any hardware or software errors generated therein, 5) distributing operating systems and application software to the various partitions, 6) causing the operating systems and software to execute, 7) backing up the state of the partition or software therein, 8) shutting down application software, and 9) shutting down a computing partition or the entire HPC system 100. These particular functions are described in more detail in the section below entitled “System Operation.”

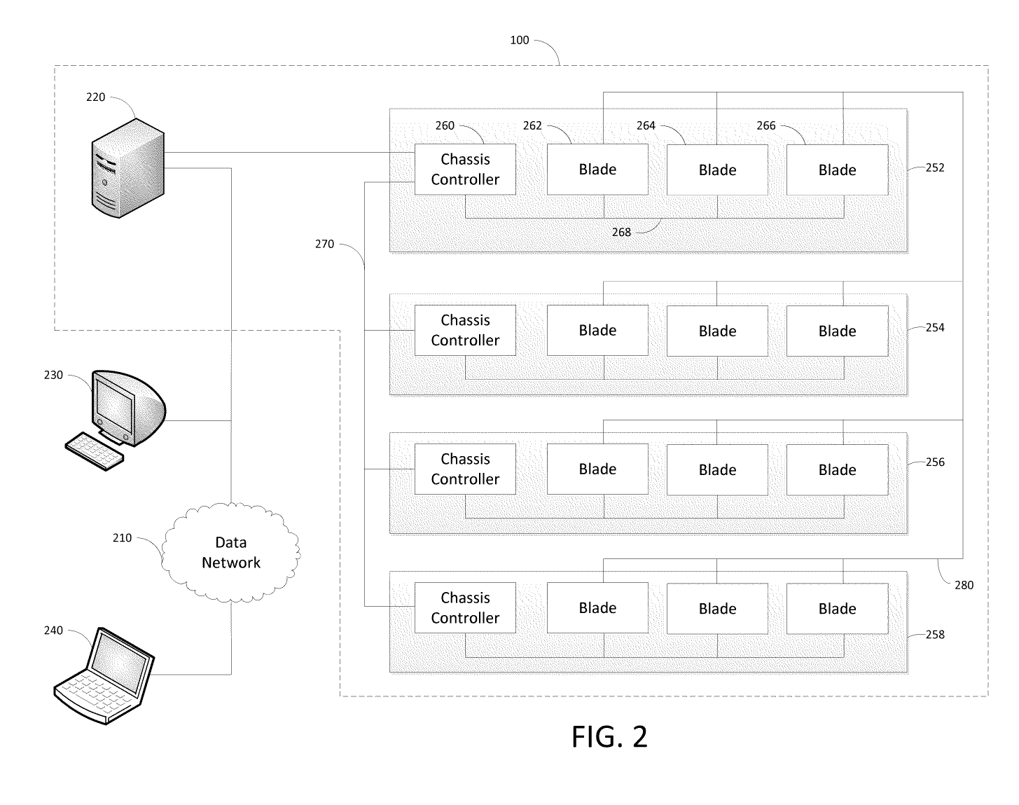

FIG. 2 schematically shows a physical view of a high performance computing system 100 in accordance with the embodiment of FIG. 1. The hardware that comprises the HPC system 100 of FIG. 1 is surrounded by the dashed line. The HPC system 100 is connected to an enterprise data network 210 to facilitate user access.

The HPC system 100 includes a system management node (“SMN”) 220 that performs the functions of the system console 110. The management node 220 may be implemented as a desktop computer, a server computer, or other similar computing device, provided either by the enterprise or the HPC system designer, and includes software necessary to control the HPC system 100 (i.e., the system console software).

The HPC system 100 is accessible using the data network 210, which may include any data network known in the art, such as an enterprise local area network (“LAN”), a virtual private network (“VPN”), the Internet, or the like, or a combination of these networks. Any of these networks may permit a number of users to access the HPC system resources remotely and/or simultaneously. For example, the management node 220 may be accessed by an enterprise computer 230 by way of remote login using tools known in the art such as Windows® Remote Desktop Services or the Unix secure shell. If the enterprise is so inclined, access to the HPC system 100 may be provided to a remote computer 240. The remote computer 240 may access the HPC system by way of a login to the management node 220 as just described, or using a gateway or proxy system as is known to persons in the art.

The hardware computing resources of the HPC system 100 (e.g., the processors, memory, non-volatile storage, and I/O devices shown in FIG. 1) are provided collectively by one or more “blade chassis,” such as blade chassis 252, 254, 256, 258 shown in FIG. 2, that are managed and allocated into computing partitions. A blade chassis is an electronic chassis that is configured to house, power, and provide high-speed data communications between a plurality of stackable, modular electronic circuit boards called “blades.” Each blade includes enough computing hardware to act as a standalone computing server. The modular design of a blade chassis permits the blades to be connected to power and data lines with a minimum of cabling and vertical space.

Accordingly, each blade chassis, for example blade chassis 252, has a chassis management controller 260 (also referred to as a “chassis controller” or “CMC”) for managing system functions in the blade chassis 252, and a number of blades 262, 264, 266 for providing computing resources. Each blade, for example blade 262, contributes its hardware computing resources to the collective total resources of the HPC system 100. The system management node 220 manages the hardware computing resources of the entire HPC system 100 using the chassis controllers, such as chassis controller 260, while each chassis controller in turn manages the resources for just the blades in its blade chassis. The chassis controller 260 is physically and electrically coupled to the blades 262-266 inside the blade chassis 252 by means of a local management bus 268, described below in more detail. The hardware in the other blade chassis 254-258 is similarly configured.

The chassis controllers communicate with each other using a management connection 270. The management connection 270 may be a high-speed LAN, for example, running an Ethernet communication protocol, or other data bus. By contrast, the blades communicate with each other using a computing connection 280. To that end, the computing connection 280 illustratively has a high-bandwidth, low-latency system interconnect, such as NumaLink, developed by Silicon Graphics International Corp. of Fremont, Calif.

The chassis controller 260 provides system hardware management functions to the rest of the HPC system. For example, the chassis controller 260 may receive a system boot command from the SMN 220, and respond by issuing boot commands to each of the blades 262-266 using the local management bus 268. Similarly, the chassis controller 260 may receive hardware error data from one or more of the blades 262-266 and store this information for later analysis in combination with error data stored by the other chassis controllers. In some embodiments, such as that shown in FIG. 2, the SMN 220 or an enterprise computer 230 are provided access to a single, master chassis controller 260 that processes system management commands to control the HPC system 100 and forwards these commands to the other chassis controllers. In other embodiments, however, an SMN 220 is coupled directly to the management connection 270 and issues commands to each chassis controller individually. Persons having ordinary skill in the art may contemplate variations of these designs that permit the same type of functionality, but for clarity only these designs are presented.

The blade chassis 252, the computing hardware of its blades 262-266, and the local management bus 268 may be provided as known in the art. However, the chassis controller 260 may be implemented using hardware, firmware, or software provided by the HPC system designer. Each blade provides the HPC system 100 with some quantity of processors, volatile memory, non-volatile storage, and I/O devices that are known in the art of standalone computer servers. However, each blade also has hardware, firmware, and/or software to allow these computing resources to be grouped together and treated collectively as computing partitions, as described below in more detail in the section entitled “System Operation.”

While FIG. 2 shows an HPC system 100 having four chassis and three blades in each chassis, it should be appreciated that these figures do not limit the scope of the invention. An HPC system may have dozens of chassis and hundreds of blades; indeed, HPC systems often are desired because they provide very large quantities of tightly-coupled computing resources.

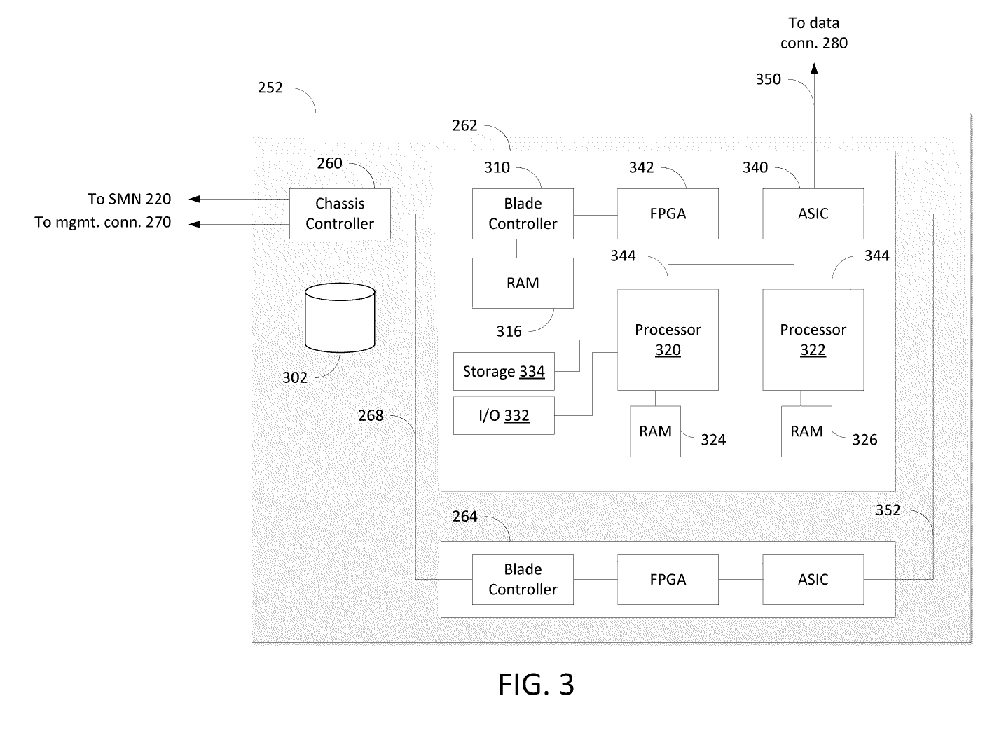

FIG. 3 schematically shows a single blade chassis 252 in more detail. In this figure, parts not relevant to the immediate description have been omitted. The chassis controller 260 is shown with its connections to the system management node 220 and to the management connection 270. The chassis controller 260 may be provided with a chassis data store 302 for storing chassis management data. In some embodiments, the chassis data store 302 is volatile random access memory (“RAM”), in which case data in the chassis data store 302 are accessible by the SMN 220 so long as power is applied to the blade chassis 252, even if one or more of the computing partitions has failed (e.g., due to an OS crash) or a blade has malfunctioned. In other embodiments, the chassis data store 302 is non-volatile storage such as a hard disk drive (“HDD”) or a solid state drive (“SSD”). In these embodiments, data in the chassis data store 302 are accessible after the HPC system has been powered down and rebooted.

FIG. 3 shows relevant portions of specific implementations of the blades 262 and 264 for discussion purposes. The blade 262 includes a blade management controller 310 (also called a “blade controller” or “BMC”) that executes system management functions at a blade level, in a manner analogous to the functions performed by the chassis controller at the chassis level. For more detail on the operations of the chassis controller and blade controller, see the section entitled “System Operation” below. The blade controller 310 may be implemented as custom hardware, designed by the HPC system designer to permit communication with the chassis controller 260. In addition, the blade controller 310 may have its own RAM 316 to carry out its management functions. The chassis controller 260 communicates with the blade controller of each blade using the local management bus 268, as shown in FIG. 3 and the previous figures.

The blade 262 also includes one or more processors 320, 322 that are connected to RAM 324, 326. Blade 262 may be alternately configured so that multiple processors may access a common set of RAM on a single bus, as is known in the art. It should also be appreciated that processors 320, 322 may include any number of central processing units (“CPUs”) or cores, as is known in the art. The processors 320, 322 in the blade 262 are connected to other items, such as a data bus that communicates with I/O devices 332, a data bus that communicates with non-volatile storage 334, and other buses commonly found in standalone computing systems. (For clarity, FIG. 3 shows only the connections from processor 320 to some devices.) The processors 320, 322 may be, for example, INTEL® Core™ processors manufactured by Intel Corporation. The I/O bus may be, for example, a PCI or PCI Express (“PCIe”) bus. The storage bus may be, for example, a SATA, SCSI, or Fibre Channel bus. It will be appreciated that other bus standards, processor types, and processor manufacturers may be used in accordance with illustrative embodiments of the present invention.

Each blade (e.g., the blades 262 and 264) includes an application-specific integrated circuit 340 (also referred to as an “ASIC”, “hub chip”, or “hub ASIC”) that controls much of its functionality. More specifically, to logically connect the processors 320, 322, RAM 324, 326, and other devices 332, 334 together to form a managed, multi-processor, coherently-shared distributed-memory HPC system, the processors 320, 322 are electrically connected to the hub ASIC 340. The hub ASIC 340 thus provides an interface between the HPC system management functions generated by the SMN 220, chassis controller 260, and blade controller 310, and the computing resources of the blade 262.

In this connection, the hub ASIC 340 connects with the blade controller 310 by way of a field-programmable gate array (“FPGA”) 342 or similar programmable device for passing signals between integrated circuits. In particular, signals are generated on output pins of the blade controller 310, in response to commands issued by the chassis controller 260. These signals are translated by the FPGA 342 into commands for certain input pins of the hub ASIC 340, and vice versa. For example, a “power on” signal received by the blade controller 310 from the chassis controller 260 requires, among other things, providing a “power on” voltage to a certain pin on the hub ASIC 340; the FPGA 342 facilitates this task.

The field-programmable nature of the FPGA 342 permits the interface between the blade controller 310 and ASIC 340 to be reprogrammable after manufacturing. Thus, for example, the blade controller 310 and ASIC 340 may be designed to have certain generic functions, and the FPGA 342 may be used advantageously to program the use of those functions in an application-specific way. The communications interface between the blade controller 310 and ASIC 340 also may be updated if a hardware design error is discovered in either module, permitting a quick system repair without requiring new hardware to be fabricated.

Also in connection with its role as the interface between computing resources and system management, the hub ASIC 340 is connected to the processors 320, 322 by way of a high-speed processor interconnect 344. In one embodiment, the processors 320, 322 are manufactured by Intel Corporation which provides the INTEL® QuickPath Interconnect (“QPI”) for this purpose, and the hub ASIC 340 includes a module for communicating with the processors 320, 322 using QPI. Other embodiments may use other processor interconnect configurations.

The hub chip 340 in each blade also provides connections to other blades for high-bandwidth, low-latency data communications. Thus, the hub chip 340 includes a link 350 to the computing connection 280 that connects different blade chassis. This link 350 may be implemented using networking cables, for example. The hub ASIC 340 also includes connections to other blades in the same blade chassis 252. The hub ASIC 340 of blade 262 connects to the hub ASIC 340 of blade 264 by way of a chassis computing connection 352. The chassis computing connection 352 may be implemented as a data bus on a backplane of the blade chassis 252 rather than using networking cables, advantageously allowing the very high speed data communication between blades that is required for high-performance computing tasks. Data communication on both the inter-chassis computing connection 280 and the intra-chassis computing connection 352 may be implemented using the NumaLink protocol or a similar protocol.

### System Operation

System management commands generally propagate from the SMN 220, through the management connection 270 to the blade chassis (and their chassis controllers), then to the blades (and their blade controllers), and finally to the hub ASICS that implement the commands using the system computing hardware.

As a concrete example, consider the process of powering on an HPC system. In accordance with exemplary embodiments of the present invention, the HPC system 100 is powered when a system operator issues a “power on” command from the SMN 220. The SMN 220 propagates this command to each of the blade chassis 252-258 by way of their respective chassis controllers, such as chassis controller 260 in blade chassis 252. Each chassis controller, in turn, issues a “power on” command to each of the respective blades in its blade chassis by way of their respective blade controllers, such as blade controller 310 of blade 262. Blade controller 310 issues a “power on” command to its corresponding hub chip 340 using the FPGA 342, which provides a signal on one of the pins of the hub chip 340 that allows it to initialize. Other commands propagate similarly.

Once the HPC system is powered on, its computing resources may be divided into computing partitions. The quantity of computing resources that are allocated to each computing partition is an administrative decision. For example, an enterprise may have a number of projects to complete, and each project is projected to require a certain amount of computing resources. Different projects may require different proportions of processing power, memory, and I/O device usage, and different blades may have different quantities of the resources installed. The HPC system administrator takes these considerations into account when partitioning the computing resources of the HPC system 100. Partitioning the computing resources may be accomplished by programming each blade's RAM 316. For example, the SMN 220 may issue appropriate blade programming commands after reading a system configuration file.

The collective hardware computing resources of the HPC system 100 may be divided into computing partitions according to any administrative need. Thus, for example, a single computing partition may include the computing resources of some or all of the blades of one blade chassis 252, all of the blades of multiple blade chassis 252 and 254, some of the blades of one blade chassis 252 and all of the blades of blade chassis 254, all of the computing resources of the entire HPC system 100, and other similar combinations. Hardware computing resources may be partitioned statically, in which case a reboot of the entire HPC system 100 is required to reallocate hardware. Alternatively and preferentially, hardware computing resources are partitioned dynamically while the HPC system 100 is powered on. In this way, unallocated resources may be assigned to a partition without interrupting the operation of other partitions.

It should be noted that once the HPC system 100 has been appropriately partitioned, each partition may be considered to act as a standalone computing system. Thus, two or more partitions may be combined to form a logical computing group inside the HPC system 100. Such grouping may be necessary if, for example, a particular computational task is allocated more processors or memory than a single operating system can control. For example, if a single operating system can control only 64 processors, but a particular computational task requires the combined power of 256 processors, then four partitions may be allocated to the task in such a group. This grouping may be accomplished using techniques known in the art, such as installing the same software on each computing partition and providing the partitions with a VPN.

Once at least one partition has been created, the partition may be booted and its computing resources initialized. Each computing partition, such as partition 160, may be viewed logically as having a single OS 191 and a single BIOS 192. As is known in the art, a BIOS is a collection of instructions that electrically probes and initializes the available hardware to a known state so that the OS can boot, and is typically provided in a firmware chip on each physical server. However, a single logical computing partition 160 may span several blades, or even several blade chassis. A processor 320 or 322 inside a blade may be referred to as a “computing node” or simply a “node” to emphasize its allocation to a particular partition. It will be understood that a physical blade may comprise more than one computing node if it has multiple processors 320, 322 and memory 324, 326.

Booting a partition in accordance with an embodiment of the invention requires a number of modifications to be made to a blade chassis that is purchased from stock. In particular, the BIOS in each blade is modified to determine other hardware resources in the same computing partition, not just those in the same blade or blade chassis. After a boot command has been issued by the SMN 220, the hub ASIC 340 eventually provides an appropriate signal to the processor 320 to begin the boot process using BIOS instructions. The BIOS instructions, in turn, obtain partition information from the hub ASIC 340 such as: an identification (node) number in the partition, a node interconnection topology, a list of devices that are present in other nodes in the partition, a master clock signal used by all nodes in the partition, and so on. Armed with this information, the processor 320 may take whatever steps are required to initialize the blade 262, including 1) non-HPC-specific steps such as initializing I/O devices 332 and non-volatile storage 334, and 2) also HPC-specific steps such as synchronizing a local hardware clock to a master clock signal, initializing HPC-specialized hardware in a given node, managing a memory directory that includes information about which other nodes in the partition have accessed its RAM, and preparing a partition-wide physical memory map.

At this point, each physical BIOS has its own view of the partition, and all of the computing resources in each node are prepared for the OS to load. The BIOS then reads the OS image and executes it, in accordance with techniques known in the art of multiprocessor systems. The BIOS presents to the OS a view of the partition hardware as if it were all present in a single, very large computing device, even if the hardware itself is scattered among multiple blade chassis and blades. In this way, a single OS instance spreads itself across some, or preferably all, of the blade chassis and blades that are assigned to its partition. Different operating systems may be installed on the various partitions. If an OS image is not present, for example immediately after a partition is created, the OS image may be installed using processes known in the art before the partition boots.

Once the OS is safely executing, its partition may be operated as a single logical computing device. Software for carrying out desired computations may be installed to the various partitions by the HPC system operator. Users may then log into the SMN 220. Access to their respective partitions from the SMN 220 may be controlled using volume mounting and directory permissions based on login credentials, for example. The system operator may monitor the health of each partition, and take remedial steps when a hardware or software error is detected. The current state of long-running application programs may be saved to non-volatile storage, either periodically or on the command of the system operator or application user, to guard against losing work in the event of a system or application crash. The system operator or a system user may issue a command to shut down application software. Other operations of an HPC partition may be known to a person having ordinary skill in the art. When administratively required, the system operator may shut down a computing partition entirely, reallocate or deallocate computing resources in a partition, or power down the entire HPC system 100.

### Floating Point Intensive Operations

In accordance with illustrative embodiments of the invention, heavily data-intensive computations are performed that require specialized hardware. Such hardware acceleration may be achieved by installing one or more coprocessors in each node. In discussing such computations, reference will be made to flops. A “flop” is a floating-point operation. “Flops” means the plural of flop when discussing the size of a computation, and one flop per second when discussing the speed of a computation.

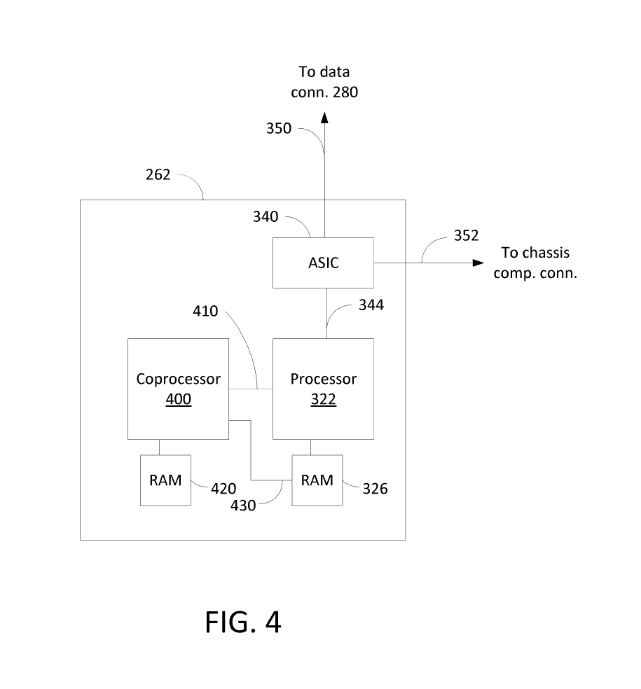

FIG. 4 schematically shows relevant details of a node inside a blade 262 of the HPC system 100 of FIG. 1 that has been optimized for such applications. Portions of FIG. 3 not relevant to further description have been omitted for clarity. In addition to the processor 322, a coprocessor 400 for performing mathematical computations is present. In one embodiment, the processor 322 is an INTEL® Xeon® processor while the coprocessor 400 is an INTEL® Xeon Phi™ coprocessor. It will be understood that other embodiments may use other coprocessors, including general purpose graphics processing units (GPGPUs) including the NVIDIA® Kepler coprocessor from Nvidia of Santa Clara, Calif., and coprocessors provided by Advanced Micro Devices, Inc. (AMD) of Sunnyvale, Calif., among others. The processor 322 is coupled to the coprocessor 400 by a command bus 410. The coprocessor 400 uses a random access memory 420 to perform computations, which is shown as being separate but may be integral to the coprocessor 400. The coprocessor 400 also may be connected to the node RAM 326 by a data bus 430. Persons having ordinary skill in the art may envision other configurations that fall within the scope of the invention; for example, each computing node may be connected to multiple coprocessors 400.

To understand the necessity of adding a coprocessor to a blade, consider multiplying two double-precision matrices each having 100,000 rows and columns. Each output entry requires about 200,000 floating point operations (i.e., one multiplication and one addition for each entry in the respective input row or column input vector), and there are 10 billion such output entries (i.e., 100,000 squared). Thus, this multiplication requires 2*10¹⁵ floating point operations, or 2000 teraflops. An INTEL® Xeon® E7-8870 processor has a theoretical maximum speed of 96 gigaflop/s; such a processor would require almost six hours to perform this task. On the other hand, the INTEL® Xeon Phi™ 7110P coprocessor is theoretically capable of 1074 double-precision gigaflop/s, over 11 times faster, and would complete in just over a half hour. By spreading this computing load across 32 coprocessors, as might be found in an HPC system partition, this huge task theoretically can be completed in less than a minute.

But rarely does actual performance meet theoretical limits. One problem is latency. The coprocessor 400 cannot store in its RAM 420 the 80 gigabytes of data required to perform this computation. For example, the INTEL® Xeon Phi™ 7110P coprocessor has only 8 GB of onboard RAM. Therefore, data must be transferred from the global shared memory space of the HPC system 100 to the coprocessor memory 420, by way of the node RAM 326. Each copy of data from the global memory to the node RAM 326, by way of data connection 280 or chassis connection 352, incurs a global-to-local latency; that is, a delay between issuance of the command to fetch the data and the appearance of the data in the RAM 326. Similarly, each copy of data from the node RAM 326 to the coprocessor 400 (and more particularly, to the coprocessor RAM 420) by way of data bus 430 incurs a local-to-coprocessor latency. Copies of data from the coprocessor RAM 420 to the node RAM 326, and from the node RAM 326 to the global shared memory also incur latencies that have approximately the same size. The presence of these latencies reduces the realized efficiency of the calculation.

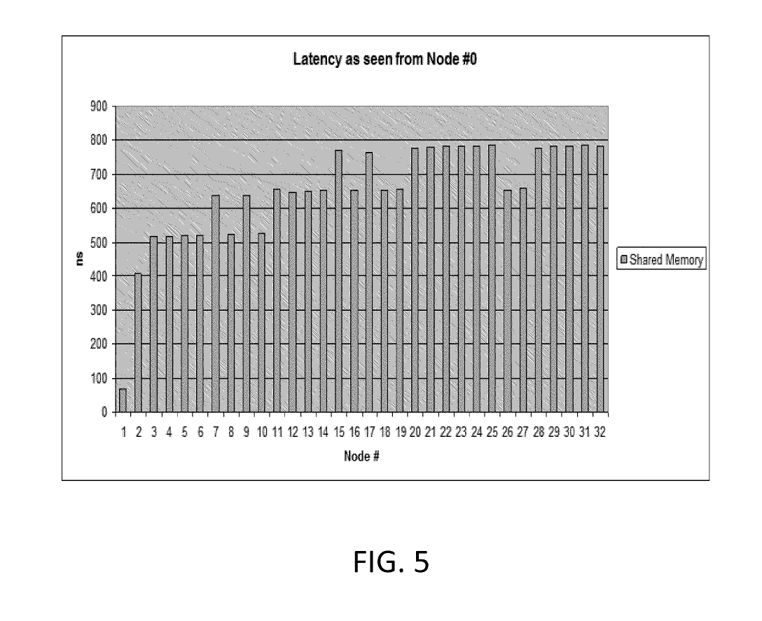

FIG. 5 is a graph showing latencies measured using the lmbench pointer chase for transferring data between shared memory of the HPC system and the node. Transfers of data between a given Node 0 and other nodes in a 32 node partition are shown. As can be seen, with the exception of Node 1, transfers of data from other nodes incur a global-to-local latency of at least 400 nanoseconds (“ns”), with some latencies measuring as high as nearly 800 ns. There is no lmbench program for measuring local-to-coprocessor latency. However, the standard MPI pingpong test would reveal that local-to-coprocessor latency is roughly ten times local-to-local latency. It follows that the global-to-local latency is generally on par with the local-to-coprocessor latency.

To reduce the effects of data transfer latency in the HPC system 100, various embodiments of the invention deploy multiple threads in the processor 322. A master thread controls the first data transfer from the HPC shared memory to the coprocessor 400, and computations in the coprocessor, while one or more slave threads execute subsequent data transfers from the HPC shared memory to the local RAM 326, and then to buffers in the coprocessor RAM 420. Two or more buffers are used to store the data in the RAM 326; these buffers are copied to the coprocessor RAM 420 for computation.

In some embodiments, the data transfer from the HPC shared memory to the coprocessor RAM 420 occurs faster than the coprocessor 400 can perform its computation on a single work unit. In this case, the slave thread(s) in the processor 322 may copy the data asynchronously, and while the transfer is occurring but before the next transfer begins, they may be used to perform a partial computation on a work unit. In this way, the coprocessor experiences no delay or latency due to a lack of work units, allowing it to execute at or near its maximum computational rate.

In other embodiments, the coprocessor 400 performs computations in less time than the latency incurred to copy data for a single workload from the HPC shared memory to the coprocessor RAM 420. In this case, a higher bandwidth of data transfer between the HPC shared memory and the coprocessor RAM 420 is required. This may be accomplished using multiple slave threads that operate on multiple data buffers in the node RAM 326 and the coprocessor RAM 420. Note that the latency to copy data between HPC shared memory and the coprocessor RAM 420 remains the same in these other embodiments. In some embodiments, each slave thread simultaneously accesses a respective data buffer, but data are copied to the coprocessor RAM 420 from each data buffer in a circular sequence.

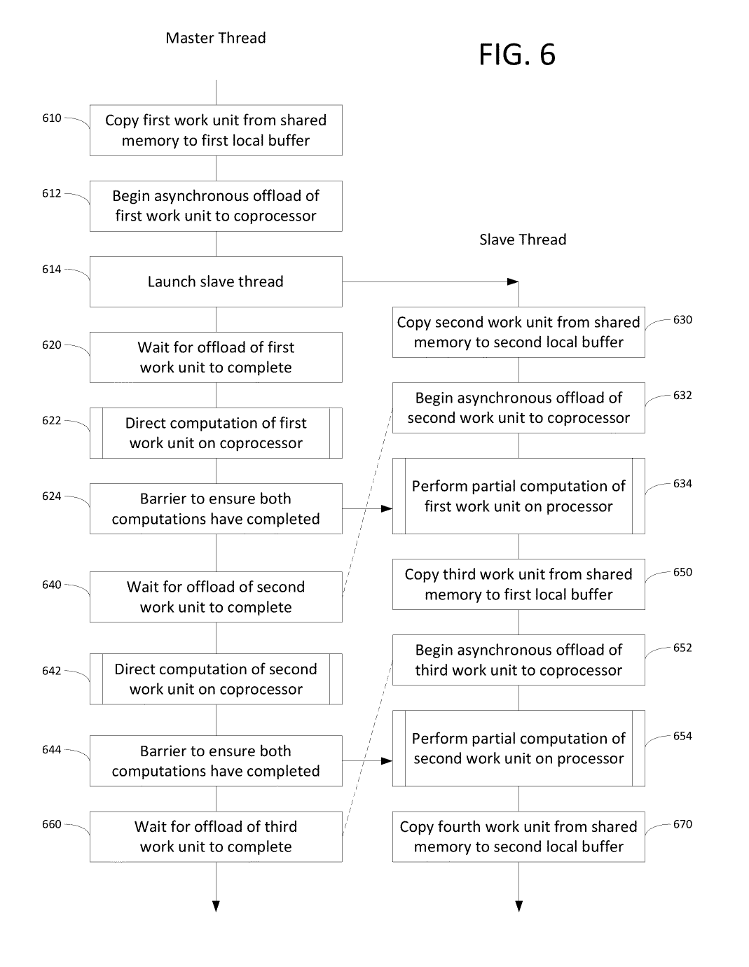

FIG. 6 shows an exemplary master-slave thread usage in a processor in accordance with an embodiment of the invention. In a first process 610, the master thread copies a first work unit from the HPC shared memory to a first local buffer in RAM 326. This copying is synchronous; that is, it prevents the master thread from doing anything else until it completes. In process 612, the master thread begins asynchronous offload of the first work unit from the RAM 326 to the coprocessor RAM 420. This offload is ordinarily accomplished by the use of a special software instruction; for example, when programming in the C language, Intel provides a special compiler pragma for use in offloading data to a Xeon Phi™ coprocessor. A software developer may define a handle in this pragma that is tested to determine if the offload has completed. Because the offload is asynchronous, the master thread may continue execution immediately. Thus, while the data for the first work unit are being copied to the coprocessor RAM 420, the master thread launches a slave thread in process 614. Note that other embodiments may use multiple slave threads to facilitate a higher bandwidth for data transfer between the HPC shared memory and the coprocessor memory 420. In these other embodiments, process 614 launches multiple slave threads.

The master thread is charged with directing computation of work units on the coprocessor 400. However, because the offload process is asynchronous, in process 620 the master thread waits for the offload of the first work unit to complete. This may be accomplished, for example, by busy-waiting on the pragma handle. Once the coprocessor 400 has the first work unit, the master thread on the processor 322 directs computation of the first work unit in process 622. The results of this computation are stored in an output buffer in the coprocessor RAM 420.

While this is occurring, the one or more slave threads are busy copying more data from the HPC shared memory, so that it will be ready when process 622 completes. To that end, in process 630, a slave thread synchronously copies a second work unit from the shared memory to a second local buffer inside the node RAM 326. This synchronous copy will incur a global-to-local latency, but the coprocessor 400 does not experience this latency because it is not ready to execute the second work unit. Then, in process 632, the slave thread in the processor 322 begins asynchronous offload of the second work unit to the coprocessor 400. When the coprocessor 400 finishes executing the first work unit, the coprocessor 400 will have the second work unit already stored in its RAM 420 if enough bandwidth is present in this offload process 632. If not enough bandwidth is present to complete the offload of the work unit by this time, then preferably the size of the work units is increased to increase the duration of their computation, as described below in more detail. Alternately, more slave threads may be used to increase the bandwidth.

Because process 632 is asynchronous, the slave thread may be able to perform computations after beginning the offload. Thus, in accordance with some embodiments, in process 634 the slave thread performs a partial computation of the first work unit in the processor 322. In this way, one part of the output buffer is computed by the coprocessor 400 and stays in a buffer in RAM 420, and the other part of the output buffer is computed by the processor 322 and stays in RAM 326. However, this advantageous use of computing resources means that the computation results arrive in the output buffer from two locations. Thus, computation of the next work unit must be suspended until the output buffer is in a known state and the input buffer for the first work unit can be emptied; that is, after both sub-computations have completed and the computed data are stored in the buffer memories of RAM 326 and RAM 420. In FIG. 6, the master thread provides a barrier in process 624, to ensure that both sub-computations have completed before proceeding to the second work unit. Although in other embodiments this function could be performed by the slave thread, such an alternate approach fails when multiple slave threads are present.

Once the first work unit has been processed, in process 640 the master thread waits until the offload of the second work unit to the coprocessor 400 has completed. Ideally, this wait requires no time, because the offload process was begun earlier by the slave thread in process 632, as indicated by the dashed line in FIG. 6. That is, in accordance with an embodiment of the invention, the copying from the shared memory to the coprocessor is conducted so that once the coprocessor 400 has begun the computation of a first work unit, it advantageously experiences no latency when accessing the second and subsequent work units for further computation. Once the second work unit is present in the coprocessor RAM 420, in process 642 the master thread directs computation of the second work unit on the coprocessor 400. By repeating this process of waiting for computation to be complete and directing the computation of the next work unit, the master thread devotes its entire remaining operation to directing computation on the coprocessor.

While the master thread is occupied, in process 650 the slave thread synchronously copies the next (third) work unit from global shared memory to a buffer in the node RAM 326. Because the first work unit has been processed, its buffer may be reused to store the third work unit. Thus, FIG. 6 illustrates a double-buffered system in which each buffer in the processor RAM 326 receives alternating work units. As before, in process 652 the slave thread begins the asynchronous offload of the next (third) work unit to the coprocessor 400 while the first thread directs computation on the coprocessor 400 of the previous (second) work unit. Then in process 654, the slave thread optionally performs a partial computation of the previous (second) work unit on the processor 326 to improve performance.

When the coprocessor 400 has completed its calculation on the second work unit, in process 644 the master thread provides a barrier to ensure coherency of the output buffer, and in process 660 waits for the offload of the third work unit to the coprocessor 400 to complete. Meanwhile, the slave thread is already busy synchronously copying the fourth work unit to the node RAM 326 in process 670. These processes continue in the master thread and the one or more slave threads until all of the work units have been processed. At that time, the two output data buffers in RAM 326 and RAM 420 are merged and copied back to the HPC shared memory.

In another embodiment, partially-complete output buffers in RAM 326 and RAM 420 may be copied back to the HPC shared memory. This alternate embodiment is useful, for example, if a checkpoint is desired to be stored. Such checkpoints can be useful in case of a system crash, in which case the partial results of the computation can be re-loaded into shared memory, saving valuable computing resources.

It should be understood that any plural number of buffers in the processor RAM 326 may be utilized for copying, and that a multiple-buffering system having more than two buffers may be used in some embodiments. In these embodiments, the buffers receive copies of data in a sequential, circular fashion. In this way, as computation of a work unit in one buffer is being performed, the next buffer or buffers receive additional work units. It should be appreciated that the double-buffered embodiment of FIG. 6 is a special case of a more general multiple-buffering implementation, and that the alternating buffer utilization shown therein is a special case of the more general circular buffer utilization just described.

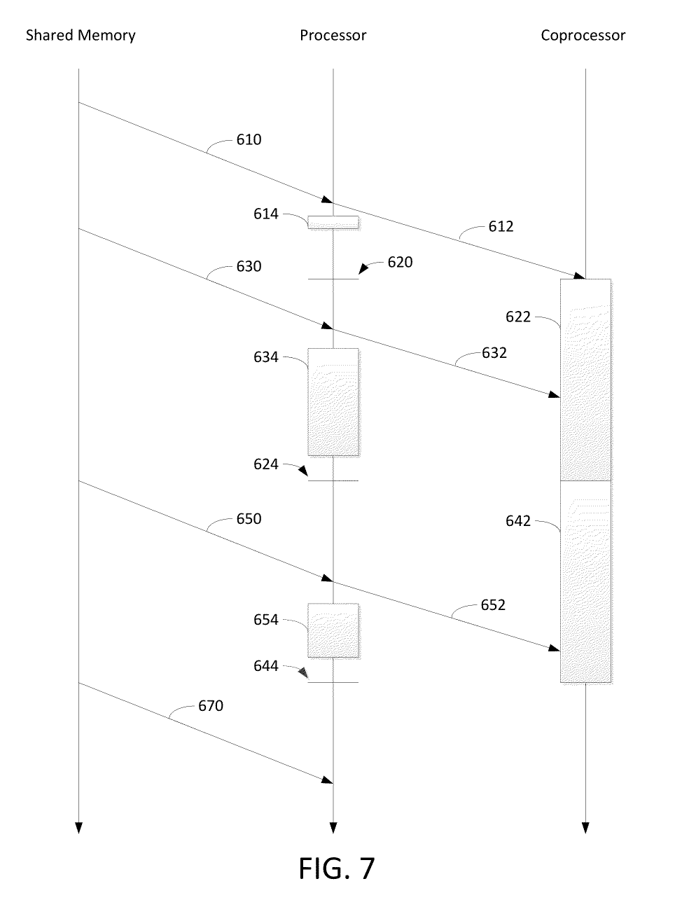

FIG. 7 shows an exemplary signal timing relating to buffering data in accordance with the embodiment of FIG. 6. The shared memory, processor 326, and coprocessor 400 are shown. As before, the first process 610 copies the first work unit synchronously from shared memory to the local RAM 326. The process 612 then copies the first work unit asynchronously from the local RAM 326 to the coprocessor 400. Because this offload process is asynchronous, the master thread is immediately free to launch the one or more slave threads in process 614. The master thread then suspends its operation until process 620, when the first work unit has completed its offload.

While the master thread is suspended, the slave thread copies the second work unit to the local RAM 326 in process 630, and from there to the coprocessor RAM 420 in process 632. Because the second offload process is asynchronous, the slave thread may use the time until the completion of the computation on the coprocessor 400 to perform a partial computation itself, in process 634. Because the processor 322 is generally slower than the coprocessor 400, the partial computation operates on much less data and generally requires less time to complete, as indicated by the fact that box 634 is shorter than box 622 in FIG. 7.

The division of work between the local processor 322 and the coprocessor 400 may be calibrated during the course of the computation according to a balance between their respective run times. That is, if process 634 completes before process 622, the next work unit may be divided so that the processor 322 does more work and the coprocessor 400 does less work, and vice versa. Such dynamic reconfiguring of the work unit divisions may continue throughout the course of the entire computation.

The master thread provides a barrier in process 624 to ensure that both sub-computations are complete. At this point, the master thread waits for the data offload begun in process 632 to complete (which it has by this point), and proceeds to process 642 to direct computation of the second work unit on the coprocessor 400. Meanwhile, the slave thread begins the process of copying the third work unit from the shared memory to the coprocessor 400 in processes 650, 652. If multiple slave threads are used with multiple buffers in an embodiment, then several work units can be copied to different locations in the coprocessor RAM 420 at once.

Multiple slave threads are useful when the duration for computation of a work unit is less than the data transfer latency. In this case, the number of slave threads should be chosen to provide enough bandwidth to accommodate the speed at which the coprocessor 400 operates (e.g. 1074 gigaflops for a Xeon Phi™ 7110P coprocessor). For example, if the coprocessor 400 finishes its task in 200 ns while the data transfer latency is 600 ns, then the coprocessor 400 could complete its calculation on three work units in the time it takes to transfer only one work unit. However, three slave threads can transfer three work units from the global shared memory to the coprocessor 400 in the same 600 ns, and thereby provide enough bandwidth to maintain constant computation in the coprocessor 400. More generally, the number of slave threads may be at least equal to the ratio between the data transfer latency and the duration for computation of a work unit. Note that the duration for computation of a work unit may be reduced by distributing the work between the processor 322 and the coprocessor 400.

If it is desired to avoid the use of multiple threads, the size of a work unit may be chosen to be sufficiently large so that the computation of each work unit takes longer than the data transfer latency. This is true for the following reason. It is known that to multiply two square matrices of order N requires a time proportional to N̂3. The proportionality constant A for computation is determined by the speeds of the processor 322 and the coprocessor 400, among other things. It is also known that the data transfer latency requires a time proportional to N̂2. The proportionality constant B for communication is determined by the network topology of the data connection 280 and the chassis computing connection 352, a data routing latency incurred in each ASIC 340 between the remote RAM and the local RAM 326, and the latency to fetch data from RAM in a number of remote nodes, among other things. If an overall multiplication is divided into a number of work units, then the execution and communication times for each work unit grow according to the same cubic and quadratic laws, respectively, but with smaller proportionality constants A′ and B′.

Because the function N̂3 grows faster than the function N̂2, there exists a well-defined mathematical crossover value of N, below which computational time is less than communication latency, and above which computational time is greater than communication latency. Because the values of N in typical HPC applications are very large, the system operator is free to choose a matrix multiplication algorithm that provides for either of these contingencies. In particular, the computational time for a work unit may be chosen to be larger than the communication latency, thereby requiring the use of only one slave thread. By using only one master thread and one slave thread, the amount of time the processor 322 spends scheduling threads is reduced, thereby advantageously permitting more time to be devoted to productive computations.

When used for matrix multiplication, the above processes consume more data than they produce. That is, more data are downloaded from shared memory to the local node (i.e., a full column of the second matrix and a number of rows of the first matrix) than are uploaded from the local node to the shared memory (i.e., a number of output entries equal to the number of rows downloaded). By contrast, sometimes the situation is reversed; that is, more data are uploaded than downloaded. For example, a vector outer product operation takes as input two vectors of length m and n, and returns a matrix having m rows and n columns. In this case, the above processes for data transfer may be reversed. In other words, the slave thread(s) may perform multiple buffering and asynchronous transfers from the output buffer of the coprocessor RAM 420 to the local RAM 326, and from there to the HPC shared memory. In some embodiments, multiple buffering in both directions (i.e., toward and from the coprocessor 400) may be used.

Although the above discussion discloses various exemplary embodiments of the invention, it should be apparent that those skilled in the art can make various modifications that will achieve some of the advantages of the invention without departing from the true scope of the invention.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, CUDA, OPENCL, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

What is claimed is:

1. A method of reducing latency of a computation having a plurality of work units, in a node of a high-performance computing system having a plurality of nodes that share a shared memory, the node having a processor and a coprocessor, the method comprising:
executing in the processor a first thread that directs computation of work units on the coprocessor;
executing in the processor one or more second threads; and
until the computation is completed:
synchronously copying, by the one or more second threads, a next work unit from the shared memory to one of a plurality of buffer memories in the node, thereby incurring a first data copying latency, and
copying the next work unit from the one of the plurality of buffer memories to the coprocessor for direction of computation by the first thread, thereby incurring a second data copying latency,
the copying from the shared memory to the coprocessor being conducted so that once the coprocessor has begun computation of a first work unit, the coprocessor experiences no data copying latency when accessing subsequent work units for computation.

2. The method of claim 1, wherein the computation includes multiplying a first matrix by a second matrix, and a work unit includes multiplying a set of rows of the first matrix by a set of columns of the second matrix.

3. The method of claim 1, wherein the computation includes forming an outer product of a first set of vectors and a second set of vectors, and a work unit includes forming an outer product of a portion of the first set of vectors and a portion of the second set of vectors.

4. The method of claim 1, wherein the size of each work unit is chosen to be sufficiently large so that the duration of computation of each work is greater than the sum of the first data copying latency and the second data copying latency.

5. The method of claim 1, wherein at least one second thread copies work units asynchronously from the plurality of buffer memories to the coprocessor.

6. The method of claim 5, wherein after starting asynchronous copy of a given work unit, the at least one second thread further performs a partial computation of a previous work unit in the processor.

7. The method of claim 1, further comprising:
for a plurality of work units, storing the results of the computation in a portion of an output data buffer in the coprocessor; and
when the computation has been performed on the plurality of work units, copying the output data buffer from the coprocessor to the shared memory.

8. The method of claim 7, further comprising:
storing the results of a partial computation of each one of the plurality of work units in a portion of an output data buffer in the processor; and
when the computation has been performed on the plurality of work units, copying the output data buffer from the processor to the shared memory.

9. A non-transitory, tangible computer readable storage medium for reducing latency of a computation having a plurality of work units, in a node of a high-performance computing system having a plurality of nodes that share a shared memory, the node having a processor and a coprocessor, the storage medium comprising program code that, when used with the processor, causes:
executing in the processor a first thread that directs computation of work units on the coprocessor;
executing in the processor one or more second threads; and
until the computation is completed:
synchronously copying, by the one or more second threads, a next work unit from the shared memory to one of a plurality of buffer memories in the node, thereby incurring a first data copying latency, and
copying the next work unit from the one of the plurality of buffer memories to the coprocessor for direction of computation by the first thread, thereby incurring a second data copying latency,
the copying from the shared memory to the coprocessor being conducted so that once the coprocessor has begun computation of a first work unit, the coprocessor experiences no data copying latency when accessing subsequent work units for computation.

10. The storage medium of claim 9, wherein the computation includes multiplying a first matrix by a second matrix, and a work unit includes multiplying a set of rows of the first matrix by a set of columns of the second matrix.

11. The storage medium of claim 9, wherein the computation includes forming an outer product of a first set of vectors and a second set of vectors, and a work unit includes forming an outer product of a portion of the first set of vectors and a portion of the second set of vectors.

12. The storage medium of claim 9, wherein the size of each work unit is chosen to be sufficiently large so that the duration of computation of each work is greater than the sum of the first data copying latency and the second data copying latency.

13. The storage medium of claim 9, further comprising program code for instructing the at least one second thread to copy work units asynchronously from the plurality of buffer memories to the coprocessor.

14. The storage medium of claim 13, further comprising program code for causing, after starting asynchronous copy of a given work unit, the at least one second thread to perform a partial computation of a previous work unit in the processor.

15. The storage medium of claim 9, further comprising:
program code for causing, for a plurality of work units, storing the results of the computation in a portion of an output data buffer in the coprocessor; and
program code for causing, when the computation has been performed on the plurality of work units, copying the output data buffer from the coprocessor to the shared memory.

16. The storage medium of claim 15, further comprising:
program code for storing the results of a partial computation of each one of the plurality of work units in a portion of an output data buffer in the processor; and
program code for causing, when the computation has been performed on the plurality of work units, copying the output data buffer from the processor to the shared memory.

17. A high-performance computing system providing reduced latency of a computation having a plurality of work units, the system comprising a plurality of interconnected nodes, each such node comprising:
a memory that is shared with other nodes in the plurality of interconnected nodes;
a coprocessor configured to perform mathematical computations;
a processor, coupled to the memory and to the coprocessor, configured to execute a first thread that directs computation of work units on the coprocessor and execute one or more second threads, wherein the processor is configured to perform, until the computation is completed, the steps of:
synchronously copying, by the one or more second threads, a next work unit from the shared memory to one of a plurality of buffer memories in the node, thereby incurring a first data copying latency, and
copying the next work unit from the one of the plurality of buffer memories to the coprocessor for direction of computation by the first thread, thereby incurring a second data copying latency,
the copying from the shared memory to the coprocessor being conducted so that once the coprocessor has begun computation of a first work unit, the coprocessor experiences no data copying latency when accessing subsequent work units for computation.

18. The system of claim 17, wherein the computation includes multiplying a first matrix by a second matrix, and a work unit includes multiplying a set of rows of the first matrix by a set of columns of the second matrix.

19. The system of claim 17, wherein the computation includes forming an outer product of a first set of vectors and a second set of vectors, and a work unit includes forming an outer product of a portion of the first set of vectors and a portion of the second set of vectors.

20. The system of claim 17, wherein the size of each work unit is chosen to be sufficiently large so that the duration of computation of each work is greater than the sum of the first data copying latency and the second data copying latency.

21. The system of claim 17, wherein the processor is further configured to copy work units asynchronously from the plurality of buffer memories to the coprocessor.

22. The system of claim 21, wherein the processor is configured to perform, after starting asynchronous copy of a given work unit, a partial computation of a previous work unit.
